(19) United States
(12) Patent Application Publication
(10) Pub. No.: US 2024/0282942 A1
(43) Pub. Date: Aug. 22, 2024

(54) ALUMINUM-BASED ANODE FOR LITHIUM-ION BATTERIES

(71) Applicants: Novelis Inc., Atlanta, GA (US); Georgia Tech Research Corporation, Atlanta, GA (US)

(72) Inventors: Matthew McDowell, Decatur, GA (US); Timothy Chen, Cary, NC (US); Diptarka Majumdar, Cumming, GA (US); Venkatesh Sundaram, Johns Creek, GA (US); Francisco Javier Quintero Cortes, Atlanta, GA (US); DaeHoon Kang, Canton, GA (US); Congcheng Wang, Atlanta, GA (US)

(73) Assignees: Novelis Inc., Atlanta, GA (US); Georgia Tech Research Corporation, Atlanta, GA (US)

(21) Appl. No.: 18/686,967

(22) PCT Filed: Sep. 9, 2022
(86) PCT No.: PCT/US2022/076169

§ 371 Date: Feb. 27, 2024

Related U.S. Application Data
(60) Provisional application No. 63/261,216, filed on Sep. 15, 2021.
(60) Provisional application No. 63/362,691, filed on Apr. 8, 2022.

(51) Int. Cl. H01M 4/36; H01M 4/02; H01M 4/46; H01M 10/0525

(52) U.S. Cl. CPC H01M 4/366; H01M 4/463; H01M 10/0525; H01M 2004/021; H01M 2004/027

(57) ABSTRACT

Described are composites having at least one layer, the at least one layer including an alloy of Al and at least another component or at least one layer including a first and second pluralities of particles. The first plurality of particles may be selected from at least one of Al particles and Al alloy particles. The second plurality of particles may be selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fc₃O₄, FeS, CuO, or combinations thereof. The composites may be used as both current collectors and active material.

### CROSS-REFERENCE TO RELATED APPLICATIONS

This application claims the benefit of and priority to U.S. Provisional Application No. 63/261,216, filed on Sep. 15, 2021, and U.S. Provisional Application No. 63/362,691, filed on Apr. 8, 2022, which are hereby incorporated by reference in their entireties.

### FIELD

The present disclosure relates to aluminum-based anodes for electrochemical cells and more specifically to aluminum current collectors used in electrodes of an electrochemical cell.

### BACKGROUND

In conventional lithium-ion batteries (LIB), copper is used as the anode current collector and aluminum (Al) is used as the cathode current collector. The anode includes an active anode material and a separate current collector, where the active anode material (usually graphite or a mixture of graphite and silicon) is typically deposited as a wet film on the current collector by slot-die coating or doctor blading and subsequently dried and cured to develop the LIB anode. While the current technology does enable a functional device, the increasing need for reduced cost of energy ($/kWh) along with enhanced driving range (miles/charge) for Electric Vehicles (EVs) requires continuing technology enhancements in battery materials. Al generally is not used as a current collector on the anode side in a lithium-ion battery because of reactive alloying of Al by lithium at the anode potentials. Advances are thus desirable if Al is to be used as an anode current collector in a lithium-ion battery.

### SUMMARY

The term “embodiment” and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In some aspects, composites having at least one layer, the at least one layer comprising a first plurality of particles and a second plurality of particles are disclosed. The first plurality of particles may be selected from at least one of Al particles and Al alloy particles and the second plurality of particles may be selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fe₃O₄, FeS, CuO, or combinations thereof. In some aspects, rather than the composite having at least one layer comprising discrete particles, the at least one layer comprises an alloy of Al and another metal, e.g., at least one of zinc, silicon, bismuth, copper, germanium, indium, antimony, tin, magnesium, or combinations thereof.

In some aspects, devices comprising: a first electrochemical cell electrode comprising a composite are disclosed. The composite comprises at least one layer and may be one or both of a current collector and an electrode active material. The composite may include at least one layer having: a first plurality of particles selected from at least one of Al particles and Al alloy particles; and a second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂. Fe₂O₃, Fe₃O₄, FeS, CuO, or combinations thereof. In some aspects, the device may comprise a composite comprising at least one layer having an alloy of Al and another metal, e.g., at least one of zinc, silicon, bismuth, copper, germanium, indium, antimony, tin, magnesium, or combinations thereof. The devices may also comprise a second electrochemical cell electrode; and an electrolyte positioned between the first electrochemical cell electrode and the second electrochemical cell electrode.

In some aspects, methods of making a composite are disclosed. The method may comprise mixing a first plurality of particles and a second plurality of particles to form a homogeneous mixture. The first plurality of particles may be selected from at least one of Al particles and Al alloy particles, and the second plurality of particles may be selected from at least one of metal particles and non-metal particles, wherein the metal particles are selected from at least one of zinc, silicon, bismuth, copper, germanium, indium, antimony, tin, magnesium, or combinations thereof. The non-metal particles may be selected from at least one of carbon, lithium titanium oxide, titania, MoO, MoS₂, Co₂O₄, MnO₂, Fe₂O₃, Fe₃O₄, FeS, CuO, or combinations thereof. The method may further comprise mechanically, thermally, or thermomechanically processing the mixture to form a composite. In some aspects, when the at least one layer of the composite comprises an alloy of Al and another metal, the method comprises forming an alloy.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1A and FIG. 1B provide schematic cross-sectional illustrations of example composites comprising a plurality of Al particles and a plurality of metal or non-metal particles.

FIG. 2 provides a plot illustrating voltage as a function of time for a pure Al foil.

FIG. 3A and FIG. 3B provide schematic cross-sectional illustrations of example composite substrates.

FIG. 4 provides a schematic cross-sectional illustration of an example electrochemical cell.

FIG. 5 provides a plot illustrating voltage as a function of time for a pure Al foil for which 80% of the capacity to hold Li is engaged.

FIG. 6A provides a plot illustrating voltage as a function of time for an example InAl composite foil for which 100% of the capacity to hold Li is engaged.

FIG. 6B provides a plot of cyclic specific capacity for the example of FIG. 6A.

FIG. 7 provides galvanostatic cycling data for a half cell including an Al foil working electrode.

FIG. 8 provides an electron micrograph image of an example composite comprising 65% Al and 35% Sn, as well as x-ray microanalysis showing distribution of Al and Sn in the composite.

FIG. 9 provides galvanostatic cycling data for an example half cell including a composite working electrode comprising 65% Al and 35% Sn.

FIG. 10 provides charge and discharge curves for an example half cell including a composite working electrode comprising 65% Al and 35% Sn.

FIG. 11 provides an electron micrograph image of an example composite comprising 51% Al and 49% Zn, as well as x-ray microanalysis showing distribution of Al and Zn in the composite.

FIG. 12 provides galvanostatic cycling data for an example half cell including a composite working electrode comprising 51% Al and 49% Zn.

FIG. 13 provides charge and discharge curves for an example half cell including a composite working electrode comprising 51% Al and 49% Zn.

FIG. 14 provides an electron micrograph image of an example composite comprising 99% Al and 1% Si, as well as x-ray microanalysis showing distribution of Al and Si in the composite.

FIG. 15 provides galvanostatic cycling data for an example half cell including a composite working electrode comprising 99% Al and 1% Si.

FIG. 16 provides charge and discharge curves for an example half cell including a composite working electrode comprising 99% Al and 1% Si.

### DETAILED DESCRIPTION

Described herein are composites including a plurality of Al or Al alloy particles and a plurality of non-Al particles, which may be metal or non-metal, distributed throughout the composite. The particles may be distributed uniformly or non-uniformly. The composite may be a current collector that may also function as an active anode material. The composite may include at least one layer and the plurality of Al or Al alloy particles and the plurality of non-Al particles may be present in one layer or in multiple layers. In some aspects, rather than the composite having at least one layer comprising discrete particles, the at least one layer comprises an alloy of Al and another metal, e.g., at least one of zinc, silicon, bismuth, copper, germanium, indium, antimony, tin, magnesium, or combinations thereof. Advantageously, the at least one layer comprising an alloy or discrete particles allows enhancement of volumetric (Wh/l) and gravimetric (Wh/kg) energy densities due to the at least partial or, in some embodiments, the complete elimination of a separate active anode layer. The composite therefore may additionally provide cost reduction due to the elimination of the processes associated with the deposition and development of the active anode layer and simplification of the manufacturing.

In aspects where the at least one layer comprises discrete particles, the non-Al particles are selected from metal and/or non-metal particles, which may be homogeneously distributed among the Al particles. Including non-Al particles may limit mechanical degradation during cyclic charging and discharging that would otherwise occur using Al or Al alloy particles alone. The same theory may apply to the at least one layer comprising an alloy of Al and another metal. The composites may be used, for example, in electronics applications, such as current collectors or electrodes for batteries, electrochemical cells, capacitors, supercapacitors, or the like.

In the context of lithium or LIB, Al is commonly used as a current collector on the cathode side. Despite the lighter weight, lower cost, and good conductivity of Al, copper is typically used as a current collector on the anode side. Generally, copper is used as a current collector on the anode side because it is non-reactive at the anode potentials and provides good conductivity. Al, on the other hand, may be reactive at the potentials common on the anode side, resulting in the alloying of the Al by lithium. This alloying of the Al by lithium may degrade or damage an Al anode current collector to a level that would render a battery with an Al anode current collector inoperable. In some cases, Al used as a cathode current collector can suffer from some corrosion or degradation, though typically in low amounts that may not impact the operability of a battery.

Despite these difficulties, Al can be used as a current collector on the cathode side of an electrochemical cell as well as the anode side. Al current collectors are achievable by providing an alloy of Al with another metal or a composite of Al particles combined with non-Al particles which prevent or limit corrosion, degradation, while still achieving good overall stability and cyclability. Al containing metal composites and/or alloys as described herein can perform dual roles of the active anode material and current collector in a lithium-ion battery. The composite material may be included to avoid mechanical degradation of the Al component during specific capacity cycling.

### Definitions and Descriptions:

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference may be made to alloys identified by AA numbers and other related designations, such as “series” or “1xxx.” For an understanding of the number designation system most commonly used in naming and identifying Al and its alloys, see “International Alloy Designations and Chemical Composition Limits for Wrought Al and Wrought Al Alloys” or “Registration Record of Al Association Alloy Designations and Chemical Compositions Limits for Al Alloys in the Form of Castings and Ingot,” both published by The Al Association.

As used herein, a plate generally has a thickness of greater than about 15 mm. For example, a plate may refer to an Al product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an Al alloy product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm). The term sheet also encompasses Al alloy products that may be referred to as foils, which may have a thickness of up to 500 μm, such as from about 1 μm to about 500 μm, for example.

As used herein, terms such as “cast metal product,” “cast product,” “cast Al alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

### Methods of Producing Al Alloy Products

The Al alloy products described herein, such as Al sheet metal and Al foils, can be prepared by casting using any suitable casting method known to those of skill in the art. As a few non-limiting examples, the casting process can include a direct chill (DC) casting process or a continuous casting (CC) process. The continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A cast ingot, cast slab, or other cast product can be processed by any suitable means. Such processing steps include, but are not limited to, homogenization, hot rolling, cold rolling, solution heat treatment, and an optional pre-aging step.

Briefly, in a homogenization step, a cast product is heated to a temperature ranging from about 400° C. to about 500° C. For example, the cast product can be heated to a temperature of about 400° C., about 410° C., about 420° C., about 430° C., about 440° C., about 450° C., about 460° C., about 470° C., about 480° C., about 490° C., or about 500° C. The product is then allowed to soak (i.e., held at the indicated temperature) for a period of time to form a homogenized product. In some examples, the total time for the homogenization step, including the heating and soaking phases, can be up to 24 hours. For example, the product can be heated up to 500° C. and soaked, for a total time of up to 18 hours for the homogenization step.

Following a homogenization step, a hot rolling step can be performed. Prior to the start of hot rolling, the homogenized product can be allowed to cool to a temperature from 300° C. to 450° C. For example, the homogenized product can be allowed to cool to a temperature of from 325° C. to 425° C. or from 350° C. to 400° C. The homogenized product can then be hot rolled at a temperature from 300° C. to 450° C. to form a hot rolled plate, a hot rolled shate or a hot rolled sheet having a gauge from 3 mm to 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature from 300° C. to 450° C. For example, the continuously cast product can be allowed to cool to a temperature of from 325° C. to 425° C. or from 350° C. to 400° C. The continuously cast products can then be hot rolled at a temperature from 300° C. to 450° C. to form a hot rolled plate, a hot rolled shate or a hot rolled sheet having a gauge from 3 mm to 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled product upon exit from the hot rolling mill is no more than 470° C., no more than 450° C., no more than 440° C., or no more than 430° C.

Cast, homogenized, or hot-rolled products can be cold rolled using cold rolling mills into thinner products, such as a cold rolled sheet. The cold rolled product can have a gauge from about 0.5 to 10 mm, e.g., from about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. In the case of foils, the cold rolled sheet can have a gauge of from about 1 μm to 500 μm, such as from 10 μm to 100 μm. The cold rolling can be performed to result in a final gauge thickness that represents a gauge reduction of up to 85%(e.g., up to 10%, up to 20%, up to 30%, up to 40%, up to 50%, up to 60%, up to 70%, up to 80%, or up to 85% reduction) or more as compared to a gauge prior to the start of cold rolling.

Subsequently, a cast, homogenized, or rolled product can undergo a solution heat treatment step. The solution heat treatment step can be any suitable treatment for the sheet which results in solutionizing of the soluble particles. The cast, homogenized, or rolled product can be heated to a peak metal temperature (PMT) of up to 590° C. (e.g., from 400° C. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is rapidly cooled at rates greater than 200° C./s to a temperature from 500 to 200° C. to form a heat-treated product. In one example, the hot product is cooled at a quench rate of above 200° C./second at temperatures from 450° C. to 200° C. Optionally, the cooling rates can be faster in other cases.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

### Methods of Using the Disclosed Al Alloy Products

The Al alloy products described herein can be used in electronics applications. For example, the Al alloy products and methods described herein can be used to prepare components for electronic devices, including batteries, mobile phones, and tablet computers. In some examples, the Al alloy products can be used to prepare current collectors and electrodes used in electrochemical cells, capacitors, or batteries, which can be used in mobile phones, tablet computers, or the like.

### Metal Alloys

Described herein are methods of treating Al alloys and the resultant treated Al alloys. In some examples, the Al alloys for use in the methods described herein can include 1xxx series Al alloys, 2xxx series Al alloys, 3xxx series Al alloys, 4xxx series Al alloys, 5xxx series Al alloys, 6xxx series Al alloys, 7xxx series Al alloys, or 8xxx series Al alloys.

By way of non-limiting example, exemplary 1xxx series Al alloys can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series Al alloys can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series Al alloys can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series Al alloys can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series Al alloys can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series Al alloys can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series Al alloys can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149,7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series Al alloys can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

### Composites

As described herein, the Al and metal alloys, and/or the Al particles and non-Al particles can provide Al alloy products, such as foils, sheets, or coatings, described herein to make composites or composite substrates, such as electronic substrates, which may be suitable for use in applications as a current collector or a device incorporating such a current collector, such as an electrode, an electrochemical cell, or a capacitor. In some examples, the composite may be provided as a metal or metal alloy sheet or a metal or metal alloy foil, but is generally referred to herein as a layer in the context of a composite substrate. For use as a composite substrate, the Al and metal alloys or the Al particles and non-Al particles may comprise a metal or metal alloy foil. In some aspects, the composite may include at least one layer, e.g., 1 layer, 2 layers, 3 layers, etc. In some aspects, the layers may each include the Al particles and non-Al particles described herein. In some aspects, the layers may each include the Al and metal alloys described herein. In some aspects, the composite only comprises the Al and metal alloy, i.e., does not contain a layer having discrete particles. In still further aspects, the composite comprises at least one layer comprising discrete particles as described herein, and comprises at least one layer comprising the Al and metal alloy described herein. The layers may each contain the same or different Al and metal alloys or Al particles and non-Al particles, or different ratios thereof. In other embodiments, some layers may contain the Al particles and non-Al particles described herein, while other layers may have different compositions.

The composite including non-Al particles may be useful for preventing or limiting corrosion, degradation, or alloying of the Al particles, such as in current collector applications for electrochemical cells or capacitors. In some examples, the non-Al particles may serve to block or otherwise prevent transmission of certain materials, such as to limit contact of those materials with the Al particles. In some examples, contacting the Al particles with lithium atoms and/or lithium ions may be deleterious, causing corrosion, reaction, and/or alloying of the Al alloy with lithium.

While use of Al as a current collector for an anode in a lithium or lithium-ion battery is generally undesirable because of the corrosion, reaction, and/or alloying that can take place at the anode potential, a current collector including a composite including Al and metal alloys or Al and non-Al particles as described herein can limit the contact, corrosion, reaction, and/or alloying of the Al particles within the composite by lithium or lithium ions, while still allowing for the bulk of transmission of electrical current by the Al and metal alloy or Al particles and/or allowing transmission of lithium atoms or lithium ions to the Al and metal alloy or particles. The lithium atoms or lithium ions are at least one of absorbed, stored, or released by the composite as described herein.

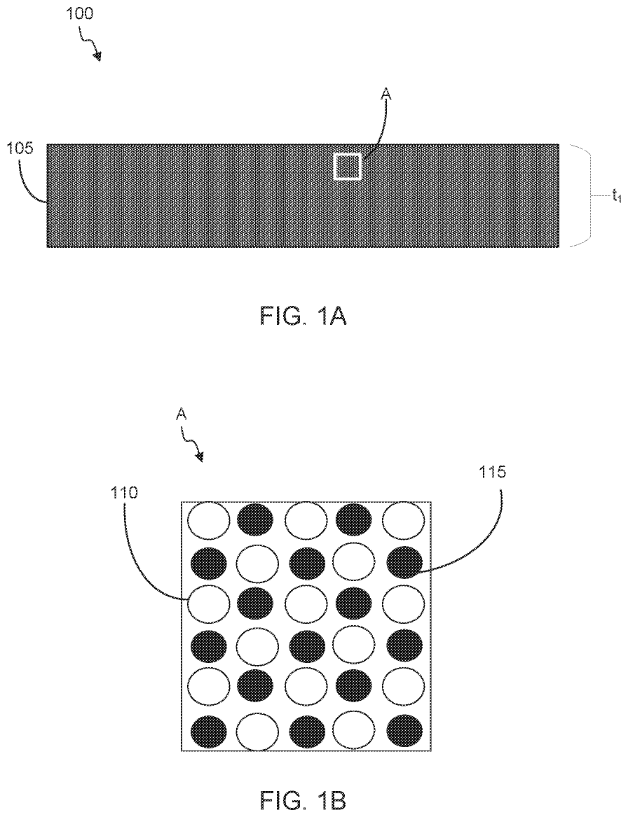

FIG. 1A provides an example of a composite 100, shown schematically in cross-section, comprising a uniform distribution 105 of Al particles and non-Al particles. Area A of FIG. 1A, shown in greater detail in FIG. 1B, illustrates schematically the uniform distribution of Al particles 110 and non-Al particles 115. The uniform distribution of Al particles 110 and non-Al particles 115 is through the thickness t₁ of the composite 100. The composite 100 is an active anode current collector serving the functions of an active anode material, enabling the flow of electrons through the device to the external circuit while allowing reversible absorption/emission of lithium ions released from the cathode, and an anode current collector, conducting electrons into and out of the device, in a monolithic composite or composite substrate.

Several aspects, however, may be optionally useful for conductive composites. As an example, the composite is electrically conductive. Exemplary composites may have an electrical conductivity of from 10⁵ S/m to 10⁸ S/m and/or an electrical resistivity of from 10⁻⁸Ω·m to 10⁻⁶Ω·m. Such an electrical conductivity and/or electrical resistivity may be sufficient to permit conduction of electrons through the composite to the Al and metal alloy or Al particles distributed therein, where the bulk of conduction can occur.

As another example, it may be beneficial for the composite to be free or substantially free of imperfections that allow transmission of lithium atoms or lithium ions to the Al and metal alloy or Al particles, such as through the thickness t₁ of the composite. As used herein, the phrase “substantially free” refers to cases where an absolute absence of a condition does not exist but for which the absence is not detrimental and does not result in failure, degradation, or lack of usability. For example, a composite that is substantially free of imperfections can include some imperfections, but the included imperfections do not inhibit the composite from adequately conducting. Example imperfections may include, but are not limited to, voids, channels, cracks, growth defects, nodular defects, troughs, or crystallographic defects, like dislocations, stacking faults, or grain boundaries. In some cases, imperfections can be filled, covered, or otherwise sealed or effectively removed by depositing a conductive sub-layer over the composite surface including imperfections.

A composite, such as composite 100, may be created by mixing a plurality of Al particles 110 and a plurality of non-Al particles 115. The first plurality of Al particles 110 can have an average particle size from 10 nm to 100 μm. Example particle sizes may be from about 10 nm to about 100 μm, such as from 10 nm to 50 nm, from 10 nm to 100 nm, from 10 nm to 500 nm, from 10 nm to 1 μm, from 10 nm to 10 μm, from 10 nm to 50 μm, from 10 nm to 100 μm, from 50 nm to 100 nm, from 50 nm to 500 nm, from 50 nm to 1 μm, from 50 nm to 10 μm, from 50 nm to 50 μm, from 50 nm to 100 μm, from 100 nm to 500 nm, from 100 nm to 1 μm, from 100 nm to 5 μm, from 100 nm to 10 μm, from 100 nm to 50 μm, from 100 nm, to 100 μm, from 500 nm to 1 μm, from 500 nm to 5 μm, from 500 nm to 10 μm, from 500 nm to 50 μm, from 500 nm to 100 μm, from 1 μm to 5 μm, from 1 μm to 10 μm, from 1 μm to 50 μm, from 1 μm to 100 μm, from 5 μm to 10 μm, from 5 μm to 50 μm, from 5 μm to 100 μm, from 10 μm to 50 μm, from 10 μm to 100 μm, or from 50 μm to 100 μm.

The second plurality of non-Al particles 115 can have an average particle size from 10 nm to 100 μm. Example particles sizes may be from about 10 nm to about 100 μm, such as from 10 nm to 50 nm, from 10 nm to 100 nm, from 10 nm to 500 nm, from 10 nm to 1 μm, from 10 nm to 10 μm, from 10 nm to 50 μm, from 10 nm to 100 μm, from 50 nm to 100 nm, from 50 nm to 500 nm, from 50 nm to 1 μm, from 50 nm to 10 μm, from 50 nm to 50 μm, from 50 nm to 100 μm, from 100 nm to 500 nm, from 100 nm to 1 μm, from 100 nm to 5 μm, from 100 nm to 10 μm, from 100 nm to 50 μm, from 100 nm, to 100 μm, from 500 nm to 1 μm, from 500 nm to 5 μm, from 500 nm to 10 μm, from 500 nm to 50 μm, from 500 nm to 100 μm, from 1 μm to 5 μm, from 1 μm to 10 μm, from 1 μm to 50 μm, from 1 μm to 100 μm, from 5 μm to 10 μm, from 5 μm to 50 μm, from 5 μm to 100 μm, from 10 μm to 50 μm, from 10 μm to 100 μm, or from 50 μm to 100 μm.

A composite, such as composite 100, may be created by mixing a plurality of Al particles 110 and a plurality of non-Al particles 115 so that the composition of the composite comprises 1 to 99 wt. % Al metal or alloy based upon the total weight of the composite. Example Al metal or alloy content may be from about 1 wt. % to about 99 wt. %, such as from 1 wt. % to 5 wt. %, 1 wt. % to 10 wt. %, 1 wt. % to 15 wt. %, 1 wt. % to 20 wt. %, 1 wt. % to 25 wt. %, 1 wt. % to 30 wt. %, 1 wt. % to 35 wt. %, 1 wt. % to 40 wt. %, 1 wt. % to 45 wt. %, 1 wt. % to 50 wt. %, 1 wt. % to 55 wt. %, 1 wt. % to 60 wt. %, 1 wt. % to 65 wt. %, 1 wt. % to 70 wt. %, 1 wt. % to 75 wt. %, 1 wt. % to 80 wt. %, 1 wt. % to 85 wt. %, 1 wt. % to 90 wt. %, 1 wt. % to 95 wt. %, 1 wt. % to 99 wt. %, 5 wt. % to 10 wt. %, 5 wt. % to 15 wt. %, 5 wt. % to 20 wt. %, 5 wt. % to 25 wt. %, 5 wt. % to 30 wt. %, 5 wt. % to 35 wt. %, 5 wt. % to 40 wt. %, 5 wt. % to 45 wt. %, 5 wt. % to 50 wt. %, 5 wt. % to 55 wt. %, 5 wt. % to 60 wt. %, 5 wt. % to 65 wt. %, 5 wt. % to 70 wt. %, 5 wt. % to 75 wt. %, 5 wt. % to 80 wt. %, 5 wt. % to 85 wt. %, 5 wt. % to 90 wt. %, 5 wt. % to 95 wt. %, 5 wt. % to 99 wt. %, 10 wt. % to 15 wt. %, 10 wt. % to 20 wt. %, 10 wt. % to 25 wt. %, 10 wt. % to 30 wt. %, 10 wt. % to 35 wt. %, 10 wt. % to 40 wt. %, 10 wt. % to 45 wt. %, 10 wt. % to 50 wt. %, 10 wt. % to 55 wt. %, 10 wt. % to 60 wt. %, 10 wt. % to 65 wt. %, 10 wt. % to 70 wt. %, 10 wt. % to 75 wt. %, 10 wt. % to 80 wt. %, 10 wt. % to 85 wt. %, 10 wt. % to 90 wt. %, 10 wt. % to 95 wt. %, 10 wt. % to 99 wt. %, 15 wt. % to 20 wt. %, 15 wt. % to 25 wt. %, 15 wt. % to 30 wt. %, 15 wt. % to 35 wt. %, 15 wt. % to 40 wt. %, 15 wt. % to 45 wt. %, 15 wt. % to 50 wt. %, 15 wt. % to 55 wt. %, 15 wt. % to 60 wt. %, 15 wt. % to 65 wt. %, 15 wt. % to 70 wt. %, 15 wt. % to 75 wt. %, 15 wt. % to 80 wt. %, 15 wt. % to 85 wt. %, 15 wt. % to 90 wt. %, 15 wt. % to 95 wt. %, 15 wt. % to 99 wt. %, 20 wt. % to 25 wt. %, 20 wt. % to 30 wt. %, 20 wt. % to 35 wt. %, 20 wt. % to 40 wt. %, 20 wt. % to 45 wt. %, 20 wt. % to 50 wt. %, 20 wt. % to 55 wt. %, 20 wt. % to 60 wt. %, 20 wt. % to 65 wt. %, 20 wt. % to 70 wt. %, 20 wt. % to 75 wt. %, 20 wt. % to 80 wt. %, 20 wt. % to 85 wt. %, 20 wt. % to 90 wt. %, 20 wt. % to 95 wt. %, 20 wt. % to 99 wt. %, 25 wt. % to 30 wt. %, 25 wt. % to 35 wt. %, 25 wt. % to 40 wt. %, 25 wt. % to 45 wt. %, 25 wt. % to 50 wt. %, 25 wt. % to 55 wt. %, 25 wt. % to 60 wt. %, 25 wt. % to 65 wt. %, 25 wt. % to 70 wt. %, 25 wt. % to 75 wt. %, 25 wt. % to 80 wt. %, 25 wt. % to 85 wt. %, 25 wt. % to 90 wt. %, 25 wt. % to 95 wt. %, 25 wt. % to 99 wt. %, 30 wt. % to 35 wt. %, 30 wt. % to 40 wt. %, 30 wt. % to 45 wt. %, 30 wt. % to 50 wt. %, 30 wt. % to 55 wt. %, 30 wt. % to 60 wt. %, 30 wt. % to 65 wt. %, 30 wt. % to 70 wt. %, 30 wt. % to 75 wt. %, 30 wt. % to 80 wt. %, 30 wt. % to 85 wt. %, 30 wt. % to 90 wt. %, 30 wt. % to 95 wt. %, 30 wt. % to 99 wt. %, 35 wt. % to 40 wt. %, 35 wt. % to 45 wt. %, 35 wt. % to 50 wt. %, 35 wt. % to 55 wt. %, 35 wt. % to 60 wt. %, 35 wt. % to 65 wt. %, 35 wt. % to 70 wt. %, 35 wt. % to 75 wt. %, 35 wt. % to 80 wt. %, 35 wt. % to 85 wt. %, 35 wt. % to 90 wt. %, 35 wt. % to 95 wt. %, 35 wt. % to 99 wt. %, 40 wt. % to 45 wt. %, 40 wt. % to 50 wt. %, 40 wt. % to 55 wt. %, 40 wt. % to 60 wt. %, 40 wt. % to 65 wt. %, 40 wt. % to 70 wt. %, 40 wt. % to 75 wt. %, 40 wt. % to 80 wt. %, 40 wt. % to 85 wt. %, 40 wt. % to 90 wt. %, 40 wt. % to 95 wt. %, 40 wt. % to 99 wt. %, 45 wt. % to 50 wt. %, from 45 wt. % to 55 wt. %, from 45 wt. % to 60 wt. %, from 45 wt. % to 65 wt. %, from 45 wt. % to 70 wt. %, from 45 wt. % to 75 wt. %, from 45 wt. % to 80 wt. %, from 45 wt. % to 85 wt. %, from 45 wt. % to 90 wt. %, 45 wt. % to 95 wt. %, 45 wt. % to 99 wt. %, from 50 wt. % to 55 wt. %, from 50 wt. % to 60 wt. %, from 50 wt. % to 65 wt. %, from 50 wt. % to 70 wt. %, from 50 wt. % to 75 wt. %, from 50 wt. % to 80 wt. %, from 50 wt. % to 85 wt. %, from 50 wt. % to 90 wt. %, 50 wt. % to 95 wt. %, 50 wt. % to 99 wt. %, from 55 wt. % to 60 wt. %, from 55 wt. % to 65 wt. %, from 55 wt. % to 70 wt. %, from 55 wt. % to 75 wt. %, from 55 wt. % to 80 wt. %, from 55 wt. % to 85 wt. %, from 55 wt. % to 90 wt. %, 55 wt. % to 95 wt. %, 55 wt. % to 99 wt. %, from 60 wt. % to 65 wt. %, from 60 wt. % to 70 wt. %, from 60 wt. % to 75 wt. %, from 60 wt. % to 80 wt. %, from 60 wt. % to 85 wt. %, from 60 wt. % to 90 wt. %, 60 wt. % to 95 wt. %, 60 wt. % to 99 wt. %, from 65 wt. % to 70 wt. %, from 65 wt. % to 75 wt. %, from 65 wt. % to 80 wt. %, from 65 wt. % to 85 wt. %, from 65 wt. % to 90 wt. %, 65 wt. % to 95 wt. %, 65 wt. % to 99 wt. %, from 70 wt. % to 75 wt. %, from 70 wt. % to 80 wt. %, from 70 wt. % to 85 wt. %, from 70 wt. % to 90 wt. %, 70 wt. % to 95 wt. %, 70 wt. % to 99 wt. %, from 75 wt. % to 80 wt. %, from 75 wt. % to 85 wt. %, from 75 wt. % to 90 wt. %, 75 wt. % to 95 wt. %, 75 wt. % to 99 wt. %, from 80 wt. % to 85 wt. %, from 80 wt. % to 90 wt. %, 80 wt. % to 95 wt. %, 80 wt. % to 99 wt. %, 85 wt. % to 90 wt. %, 85 wt. % to 95 wt. %, 85 wt. % to 99 wt. %, 90 wt. % to 95 wt. %, 90 wt. % to 99 wt. %, or from 95 wt. % to 99 wt. %. In some embodiments, the composite comprises 45 to 90 wt. % Al metal or alloy. In other embodiments, the composite comprises 40 to 70 wt. % Al metal or alloy, from 45 to 65 wt. %, or from 50 to 55 wt. %. In some embodiments, the composite composition includes 53 wt. % Al metal or alloy. The composite composition balance comprises the non-Al metal or alloy component or components. Combinations of Al metal and Al alloys are also contemplated.

In other words, the composition of the composite comprises 1 to 99 wt. % non-Al metal or alloy based upon the total weight of the composite. Example non-Al metal or alloy content may be from about 1 wt. % to about 99 wt. %, such as from 1 wt. % to 5 wt. %, 1 wt. % to 10 wt. %, 1 wt. % to 15 wt. %, 1 wt. % to 20 wt. %, 1 wt. % to 25 wt. %, 1 wt. % to 30 wt. %, 1 wt. % to 35 wt. %, 1 wt. % to 40 wt. %, 1 wt. % to 45 wt. %, 1 wt. % to 50 wt. %, 1 wt. % to 55 wt. %, 1 wt. % to 60 wt. %, 1 wt. % to 65 wt. %, 1 wt. % to 70 wt. %, 1 wt. % to 75 wt. %, 1 wt. % to 80 wt. %, 1 wt. % to 85 wt. %, 1 wt. % to 90 wt. %, 1 wt. % to 95 wt. %, 1 wt. % to 99 wt. %, 5 wt. % to 10 wt. %, 5 wt. % to 15 wt. %, 5 wt. % to 20 wt. %, 5 wt. % to 25 wt. %, 5 wt. % to 30 wt. %, 5 wt. % to 35 wt. %, 5 wt. % to 40 wt. %, 5 wt. % to 45 wt. %, 5 wt. % to 50 wt. %, 5 wt. % to 55 wt. %, 5 wt. % to 60 wt. %, 5 wt. % to 65 wt. %, 5 wt. % to 70 wt. %, 5 wt. % to 75 wt. %, 5 wt. % to 80 wt. %, 5 wt. % to 85 wt. %, 5 wt. % to 90 wt. %, 5 wt. % to 95 wt. %, 5 wt. % to 99 wt. %, 10 wt. % to 15 wt. %, 10 wt. % to 20 wt. %, 10 wt. % to 25 wt. %, 10 wt. % to 30 wt. %, 10 wt. % to 35 wt. %, 10 wt. % to 40 wt. %, 10 wt. % to 45 wt. %, 10 wt. % to 50 wt. %, 10 wt. % to 55 wt. %, 10 wt. % to 60 wt. %, 10 wt. % to 65 wt. %, 10 wt. % to 70 wt. %, 10 wt. % to 75 wt. %, 10 wt. % to 80 wt. %, 10 wt. % to 85 wt. %, 10 wt. % to 90 wt. %, 10 wt. % to 95 wt. %, 10 wt. % to 99 wt. %, 15 wt. % to 20 wt. %, 15 wt. % to 25 wt. %, 15 wt. % to 30 wt. %, 15 wt. % to 35 wt. %, 15 wt. % to 40 wt. %, 15 wt. % to 45 wt. %, 15 wt. % to 50 wt. %, 15 wt. % to 55 wt. %, 15 wt. % to 60 wt. %, 15 wt. % to 65 wt. %, 15 wt. % to 70 wt. %, 15 wt. % to 75 wt. %, 15 wt. % to 80 wt. %, 15 wt. % to 85 wt. %, 15 wt. % to 90 wt. %, 15 wt. % to 95 wt. %, 15 wt. % to 99 wt. %, 20 wt. % to 25 wt. %, 20 wt. % to 30 wt. %, 20 wt. % to 35 wt. %, 20 wt. % to 40 wt. %, 20 wt. % to 45 wt. %, 20 wt. % to 50 wt. %, 20 wt. % to 55 wt. %, 20 wt. % to 60 wt. %, 20 wt. % to 65 wt. %, 20 wt. % to 70 wt. %, 20 wt. % to 75 wt. %, 20 wt. % to 80 wt. %, 20 wt. % to 85 wt. %, 20 wt. % to 90 wt. %, 20 wt. % to 95 wt. %, 20 wt. % to 99 wt. %, 25 wt. % to 30 wt. %, 25 wt. % to 35 wt. %, 25 wt. % to 40 wt. %, 25 wt. % to 45 wt. %, 25 wt. % to 50 wt. %, 25 wt. % to 55 wt. %, 25 wt. % to 60 wt. %, 25 wt. % to 65 wt. %, 25 wt. % to 70 wt. %, 25 wt. % to 75 wt. %, 25 wt. % to 80 wt. %, 25 wt. % to 85 wt. %, 25 wt. % to 90 wt. %, 25 wt. % to 95 wt. %, 25 wt. % to 99 wt. %, 30 wt. % to 35 wt. %, 30 wt. % to 40 wt. %, 30 wt. % to 45 wt. %, 30 wt. % to 50 wt. %, 30 wt. % to 55 wt. %, 30 wt. % to 60 wt. %, 30 wt. % to 65 wt. %, 30 wt. % to 70 wt. %, 30 wt. % to 75 wt. %, 30 wt. % to 80 wt. %, 30 wt. % to 85 wt. %, 30 wt. % to 90 wt. %, 30 wt. % to 95 wt. %, 30 wt. % to 99 wt. %, 35 wt. % to 40 wt. %, 35 wt. % to 45 wt. %, 35 wt. % to 50 wt. %, 35 wt. % to 55 wt. %, 35 wt. % to 60 wt. %, 35 wt. % to 65 wt. %, 35 wt. % to 70 wt. %, 35 wt. % to 75 wt. %, 35 wt. % to 80 wt. %, 35 wt. % to 85 wt. %, 35 wt. % to 90 wt. %, 35 wt. % to 95 wt. %, 35 wt. % to 99 wt. %, 40 wt. % to 45 wt. %, 40 wt. % to 50 wt. %, 40 wt. % to 55 wt. %, 40 wt. % to 60 wt. %, 40 wt. % to 65 wt. %, 40 wt. % to 70 wt. %, 40 wt. % to 75 wt. %, 40 wt. % to 80 wt. %, 40 wt. % to 85 wt. %, 40 wt. % to 90 wt. %, 40 wt. % to 95 wt. %, 40 wt. % to 99 wt. %, 45 wt. % to 50 wt. %, from 45 wt. % to 55 wt. %, from 45 wt. % to 60 wt. %, from 45 wt. % to 65 wt. %, from 45 wt. % to 70 wt. %, from 45 wt. % to 75 wt. %, from 45 wt. % to 80 wt. %, from 45 wt. % to 85 wt. %, from 45 wt. % to 90 wt. %, 45 wt. % to 95 wt. %, 45 wt. % to 99 wt. %, from 50 wt. % to 55 wt. %, from 50 wt. % to 60 wt. %, from 50 wt. % to 65 wt. %, from 50 wt. % to 70 wt. %, from 50 wt. % to 75 wt. %, from 50 wt. % to 80 wt. %, from 50 wt. % to 85 wt. %, from 50 wt. % to 90 wt. %, 50 wt. % to 95 wt. %, 50 wt. % to 99 wt. %, from 55 wt. % to 60 wt. %, from 55 wt. % to 65 wt. %, from 55 wt. % to 70 wt. %, from 55 wt. % to 75 wt. %, from 55 wt. % to 80 wt. %, from 55 wt. % to 85 wt. %, from 55 wt. % to 90 wt. %, 55 wt. % to 95 wt. %, 55 wt. % to 99 wt. %, from 60 wt. % to 65 wt. %, from 60 wt. % to 70 wt. %, from 60 wt. % to 75 wt. %, from 60 wt. % to 80 wt. %, from 60 wt. % to 85 wt. %, from 60 wt. % to 90 wt. %, 60 wt. % to 95 wt. %, 60 wt. % to 99 wt. %, from 65 wt. % to 70 wt. %, from 65 wt. % to 75 wt. %, from 65 wt. % to 80 wt. %, from 65 wt. % to 85 wt. %, from 65 wt. % to 90 wt. %, 65 wt. % to 95 wt. %, 65 wt. % to 99 wt. %, from 70 wt. % to 75 wt. %, from 70 wt. % to 80 wt. %, from 70 wt. % to 85 wt. %, from 70 wt. % to 90 wt. %, 70 wt. % to 95 wt. %, 70 wt. % to 99 wt. %, from 75 wt. % to 80 wt. %, from 75 wt. % to 85 wt. %, from 75 wt. % to 90 wt. %, 75 wt. % to 95 wt. %, 75 wt. % to 99 wt. %, from 80 wt. % to 85 wt. %, from 80 wt. % to 90 wt. %, 80 wt. % to 95 wt. %, 80 wt. % to 99 wt. %, 85 wt. % to 90 wt. %, 85 wt. % to 95 wt. %, 85 wt. % to 99 wt. %, 90 wt. % to 95 wt. %, 90 wt. % to 99 wt. %, or from 95 wt. % to 99 wt. %. In some embodiments, the composite composition includes 10 to 55 wt. % non-Al metal or alloy based upon the total weight of the composite. In some embodiments, the composite composition includes from 40 to 70 wt. % non-Al metal or alloy, from 45 to 65 wt. %, from 45 to 50 wt. %, or 47 wt. % non-Al metal or alloy, such as 47 wt. % indium. Combinations of non-Al metals and non-Al alloys are also contemplated.

The ratio of Al metal or Al alloy to non-Al metal or alloy may range from 1:99 to 99:1, from 1:95 to 95:1, from 1:90 to 90:1, from 1:85 to 85:1, from 1:80 to 80:1, from 1:75 to 75:1, from 1:70 to 70:1, from 1:65 to 65:1, from 1:60 to 60:1, from 1:55 to 55:1, from 1:50 to 50:1, from 1:45 to 45:1, from 1:40 to 40:1, from 1:35 to 35:1, from 1:30 to 30:1, from 1:25 to 25:1, from 1:20 to 20:1, from 1:15 to 15:1, from 1:10 to 10:1, from 1:5 to 5:1, from 1:3 to 3:1, from 1:2 to 2:1, or approximately 1:1.

It may also be beneficial for the composite including a first plurality of Al particles and a second plurality of non-Al particles, each plurality optionally uniformly distributed, and each plurality to be of high purity, such as having an amount of impurities of 15% or less, 10% or less, 5% or less, 1% or less, 0.1% or less, or 0.01% or less. For example, oxygen may be considered an impurity in a composite. In some embodiments, the composite can have an oxygen content of 50 atomic % or less. In some embodiments, the first plurality of Al particles and second plurality of non-Al particles each have a purity of 90 wt. % or more. In other embodiments, the first plurality of Al particles and second plurality of non-Al particles each have a purity of 95 wt. % or more. In yet other embodiments, the first plurality of Al particles and second plurality of non-Al particles each have a purity of 99 wt. % or more. The alloy of Al and another metal may have the same purity as described for the discrete particles.

The composite, such as composite 100, can have an average thickness t₁ from 10 nm to 150 μm. Example thicknesses may be from about 10 nm to about 150 μm, such as from 10 nm to 50 nm, from 10 nm to 100 nm, from 10 nm to 500 nm, from 10 nm to 1 μm, from 10 nm to 10 μm, from 10 nm to 50 μm, from 10 nm to 100 μm, from 10 nm to 150 μm, from 50 nm to 100 nm, from 50 nm to 500 nm, from 50 nm to 1 μm, from 50 nm to 10 μm, from 50 nm to 50 μm, from 50 nm to 100 μm, from 50 nm to 150 μm, from 100 nm to 500 nm, from 100 nm to 1 μm, from 100 nm to 5 μm, from 100 nm to 10 μm, from 100 nm to 50 μm, from 100 nm, to 100 μm, from 100 nm to 150 μm, from 500 nm to 1 μm, from 500 nm to 5 μm, from 500 nm to 10 μm, from 500 nm to 50 μm, from 500 nm to 100 μm, from 500 nm to 150 μm, from 1 μm to 5 μm, from 1 μm to 10 μm, from 1 μm to 50 μm, from 1 μm to 100 μm, from 1 μm to 150 μm, from 5 μm to 10 μm, from 5 μm to 50 μm, from 5 μm to 100 μm, from 5 μm to 150 μm, from 10 μm to 50 μm, from 10 μm to 100 μm, from 10 μm to 150 μm, from 50 μm to 100 μm, or from 50 μm to 150 μm.

The composites described herein may comprise multiple components/layers. At least one component is the plurality of Al particles, which is present in an amount of at least 10% by weight. Another component is a plurality of non-Al particles, i.e., particles that do not include Al. Materials useful for the non-Al particles of the second plurality include particles that do not alloy with lithium. Stated another way, in some embodiments, it may be useful for the non-Al particles to exclude metals that alloy with lithium. For example, the non-Al particles may exclude Al, zinc, magnesium, silicon, germanium, tin, indium, antimony, and/or carbon. In other embodiments, these non-AI particles may specifically be included.

Non-Al particles useful for the composite may include materials that are non-reactive with lithium at potentials of from 0 V to 5 V vs. Li/Lⁱ⁺. The composite may be characterized as having a specific capacity of from 450 mAh/g to 1000 mAh/g for at least 14 cycles (120 hours). In some examples, the composite may be characterized as having an areal capacity of greater than or about 2 mAh/cm². The composite may be characterized as having a lithiation percentage of from 50% to 100%. In some cases, when these non-Al particles are used or included in a composite, such particles may be attacked by lithium atoms or lithium ions and result in lithium atoms or lithium ions reaching the Al particles and corroding, alloying with, or otherwise degrading the Al containing composite. Specific materials useful for the non-Al particles may be selected from at least one of metal particles and non-metal particles. The metal particles may be selected from at least one of zinc, silicon, bismuth, copper, germanium, indium, antimony, tin, magnesium, or combinations thereof. The non-metal particles may be selected from at least one of carbon, lithium titanium oxide, titania, MoO, MoS₂, Co₂O₄, MnO₂Fe₂O₃, Fe₃O₄, FeS, CuO, or combinations thereof. The composites may be used as both current collectors and active material.

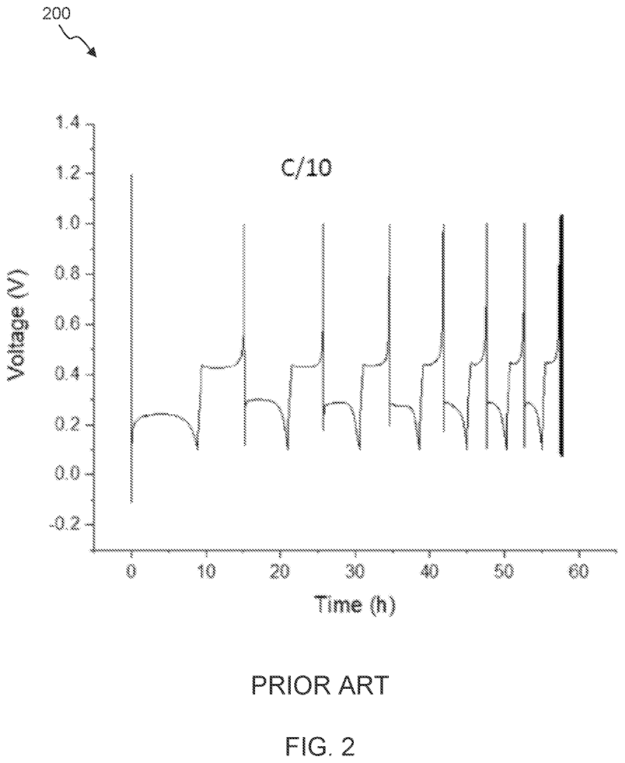

FIG. 2 is a plot illustrating voltage as a function of time for a comparative pure Al foil in a half cell of Al paired with a Li counter electrode. As shown, specific capacity cycles are shorter as Al is consumed.

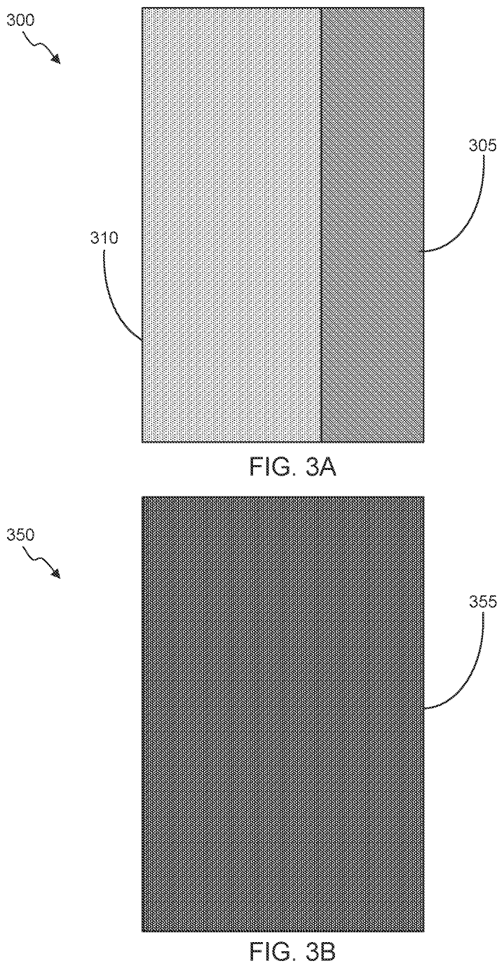

As noted above, the composites described herein can be used as electronic substrates, such as for current collectors or as electrode components in electrochemical cells and capacitors. FIG. 3A provides a cross-sectional schematic illustration of an example device, corresponding to an electrode 300, which may be a component of an electrochemical cell (e.g., a primary electrochemical cell or a secondary electrochemical cell). Electrode 300 includes a composite 305, as either an anode current collector or a cathode current collector, and an active material 310. Active material 310 may correspond to the material at which electrochemical reactions take place during charging or discharging of an electrochemical cell. Active material 310 may correspond to a cathode active material or an anode active material in different embodiments. Example materials for electrode active material 310 include lithium-ion battery anode active materials, such as intercalation materials, like graphite. In some cases, a metallic lithium anode active material may be used, such as for primary batteries. Exemplary materials for electrode active material 310 include lithium-ion battery cathode active materials, such as a lithium-based materials, including lithium cobalt oxide, lithium iron phosphate, lithium manganese oxide, lithium nickel manganese cobalt oxide, lithium nickel cobalt Al oxide, or the like.

FIG. 3B provides a cross-sectional schematic illustration of an example device, corresponding to an electrode 350, which may be a component of an electrochemical cell (e.g., a primary electrochemical cell or a secondary electrochemical cell). Electrode 350 includes a composite 355, as either an anode current collector or a cathode current collector, which also serves as an active material. Advantageously, a separate active material is not required for electrode 350.

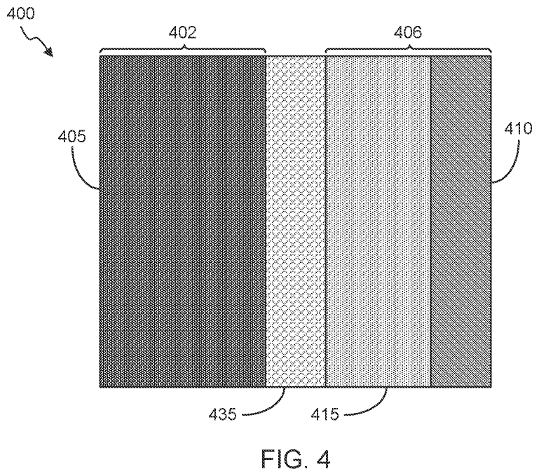

FIG. 4 shows a cross-sectional schematic illustration of an example device, corresponding to an electrochemical cell 400. Electrochemical cell 400 includes a first electrode 402, which may correspond to an anode in some examples, and a second electrode 406, which may correspond to a cathode in some examples. The first electrode 402 of electrochemical cell 400 includes a composite 405 comprising a plurality of Al particles uniformly distributed with a plurality of non-Al particles as described herein. Composite 405 of electrode 402 functions as both a first current collector and a first active material, such as an anode active material. The second electrode 406 of electrochemical cell 400 includes a second current collector 410 and a second active material 415, such as a cathode active material. Electrochemical cell 400 also includes a separator and/or an electrolyte, illustrated as component 435. A separator and/or electrolyte may be useful for preventing the first electrode active material of composite 405 and the second electrode active material 415 from contacting one another while still allowing ions to be transported across during charging or discharging. Example separators may be or include non-reactive porous materials, such as polymeric membranes like polypropylene, poly(methyl methacrylate), or polyacrylonitrile. Example electrolytes may be or include an organic solvent, such as ethylene carbonate, dimethyl carbonate, or diethyl carbonate, or solid or ceramic electrolytes. Electrolytes may include dissolved lithium salts, such as LiPF₆, LiBF₄, or LiCIO₄, and other additives.

Further, electrochemical cell 400 may be used in or as components of other devices, such as portable electronic devices, mobile phones, tablet computers, or the like. For example, the first current collector of composite 405 of anode 402 and the second current collector 410 of cathode 406 of electrochemical cell 400 may be positioned in direct or indirect communication with and receiving or providing current to an electronic device or circuitry of an electronic device.

Also described herein is a method of making a composite. The method includes mixing a plurality of Al particles and a plurality of non-Al particles to form a homogeneous mixture. The non-Al particles may be indium particles or other non-Al particles as described herein. The mixture may be mechanically, thermally, or thermomechanically processed to form a composite. The plurality of Al particles and the plurality of non-Al particles are optionally uniformly distributed throughout the composite. The mechanical, thermal, or thermomechanical processing of the mixture may include rolling, power processing, and/or chemical vapor deposition. The composite may comprise or correspond to an electronic substrate, a current collector, a capacitor, a supercapacitor, a current collector for an electrochemical cell, a current collector for a lithium-ion electrochemical cell, or combinations thereof.

The composite may also be made to have an engineered structure. By engineering the structure, the structure may include additional space and micro-porosity. Without being bound by theory, such additional space and/or micro-porosity may compensate for volume changes within the composite. Various methods may be used to form this engineered structure, including powder metallurgy, forming a micro-porous or nano-porous structure by additive manufacturing, using metallic foams, forming perforations by laser or deep etching, or other methods.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### Example 1—Electrochemical Cell Tests of Half-Cells

To test the effectiveness of different conductive protection layers, half-cells were constructed with a composite as a working electrode, lithium metal as a counter electrode, and a separator soaked with electrolyte between the composite and the lithium metal. The composite includes a plurality of Al particles uniformly distributed with a plurality of non-Al particles. Various composites were tested. Cyclic voltammograms were obtained using by controlling the applied voltage or current with a potentiostat to determine which protective layers improve the stability of Al alloy as a current collector at low potentials, similar to those at the anode side of a lithium-ion electrochemical cell.

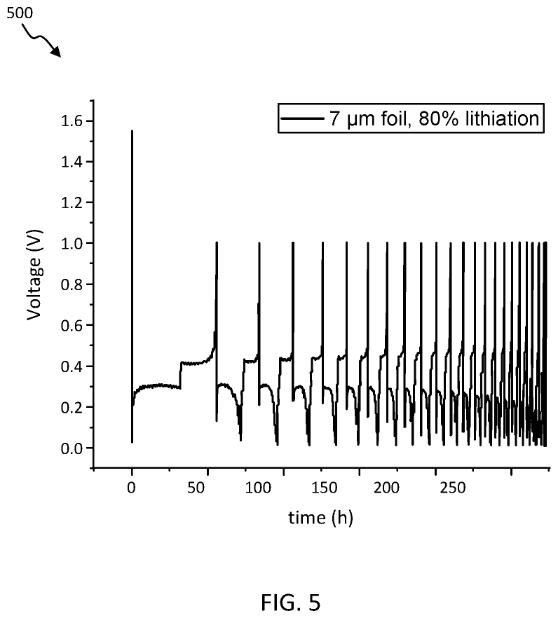

FIG. 5 provides a plot 500 illustrating voltage as a function of time for a sample comparative pure Al foil for which 80% of the capacity to hold Li is engaged. The Al foil thickness was 7 μm.

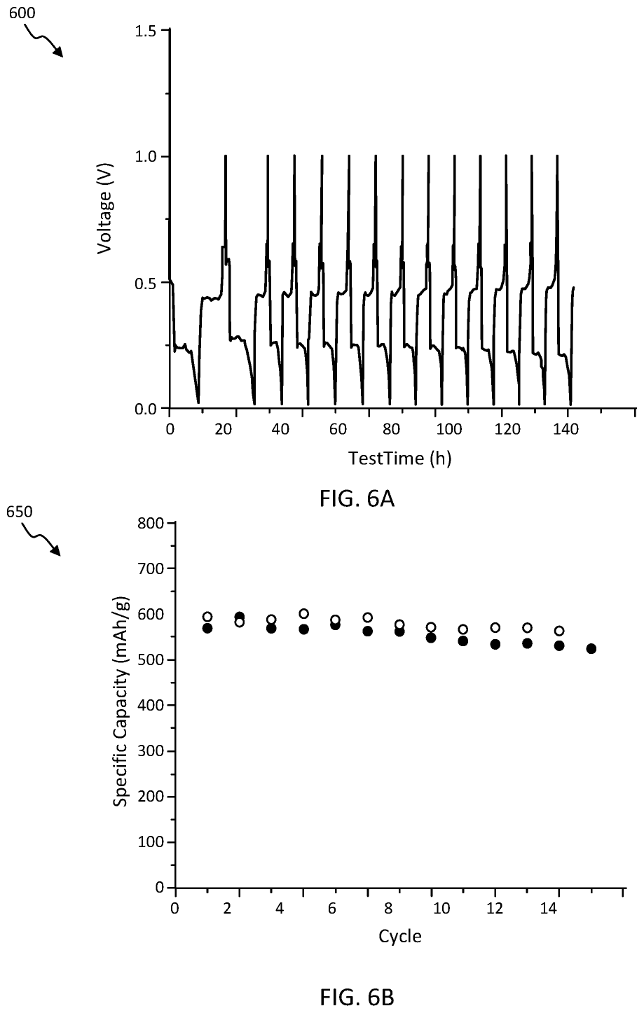

FIG. 6A provides a plot 600 illustrating voltage as a function of time for an example InAl composite foil for which 100% of the capacity to hold Li is engaged. The InAl foil was paired with Li using LiPF₆ electrochemical cell (EC) and separated by a DEC and FEC electrolyte and a cycling rate of C/5 and a mass of 0.81 mg (4.32 mAh/cm² theoretical areal capacity). As compared with the comparative Al foil as in FIG. 5, the example of FIG. 6A shows maintained performance over time. FIG. 6B provides a plot 650 of cyclic specific capacity for the example of FIG. 6A showing minimal loss of specific capacity over 14 cycles. Each cycle is about 8 h and 14 cycles corresponds to about 120 h.

### Example 2—Understanding the Electrochemical Behavior of Multi-Component Aluminum-Based Foils as Anodes for Lithium-Ion Batteries

Alloy anodes are promising materials for next-generation lithium batteries. The intrinsic properties of aluminum, such as high capacity, light weight, earth abundance, and low cost, make it a competitive alloy anode candidate in lithium batteries. Furthermore, the ability to readily manufacture aluminum-based foils and provide advantages for potentially simplifying battery manufacturing processes. However, utilization of Al anodes may experience capacity fading during charge and discharge.

To improve cycling performance, aluminum alloys and composite foil structures were fabricated to investigate their reversibility for Li storage in Li-ion batteries. Alloy foils including Al—Sn, Al—Zn, and Al—In were fabricated with contents ranging from 50 to 99 atomic % Al, and the electrochemical behavior of these materials as anodes for Li-ion batteries were investigated. With these materials, the effects of composition, structure, and morphology on the cycling performance of the alloy foils were investigated using battery-relevant capacity metrics (areal capacity of >2 mAh/cm² with foil thickness <50 microns). Results show that the composition of the foils can play a significant role in determining the electrochemical cycling capability of these foils. Furthermore, the foil processing characteristics may also be important in determining the achievable specific capacity, rate behavior, and cycle life of these foils anodes. This effort indicates the promise of foil-based alloy anodes and provides guidance toward engineering strategies to improve performance.

### Example 3—Benchmarking the Electrochemical Degradation Behavior of Aluminum Foil Anodes for Lithium-ion Batteries

Aluminum is an attractive candidate for replacing graphite anodes in lithium-ion batteries because it has high specific capacity (e.g., up to or about 990 mAh g-1), and directly using aluminum foil as the anode structure can eliminate the need for slurry-coating processes. However, achieving highly reversible lithiation and delithiation of aluminum may be impacted by volume changes during transformation, sluggish lithium-ion transport through the surface oxide layer, and poor initial Coulombic efficiency, which can all lead to degradation during cycling. Studies have focused on understanding the fundamental electrochemical reaction and material transformation behaviors of aluminum, yet there has not been a focus on how different aluminum alloy compositions behave and degrade under electrochemical cycling conditions.

Comprehensive electrochemical testing has been carried out to benchmark the performance of three different aluminum alloy foils under different cycling conditions. For foils of constant thickness, it was found that the foil compositions exhibit a power-law dependence of cycle life on the areal capacity lithiated per cycle, revealing that degradation may be significantly accelerated when high areal capacities are used each cycle. Furthermore, the composition of the aluminum alloy was found to strongly affect the Coulombic efficiency over the first 10 cycles, with higher purity foils exhibiting higher Coulombic efficiency. Finally, ex situ scanning electron microscopy and operando optical microscopy revealed different reaction mechanisms and mechanical degradation behavior amongst the different alloys. Based on understanding these various parameters, it was determined how full cells with aluminum anodes can be cycled for hundreds of cycles at relatively low areal capacities. The improved understanding of the behavior of aluminum foil anodes paves the way for future work intended to engineer aluminum-based foils with enhanced stability.

### Example 4—Aluminum Foil Half Cell

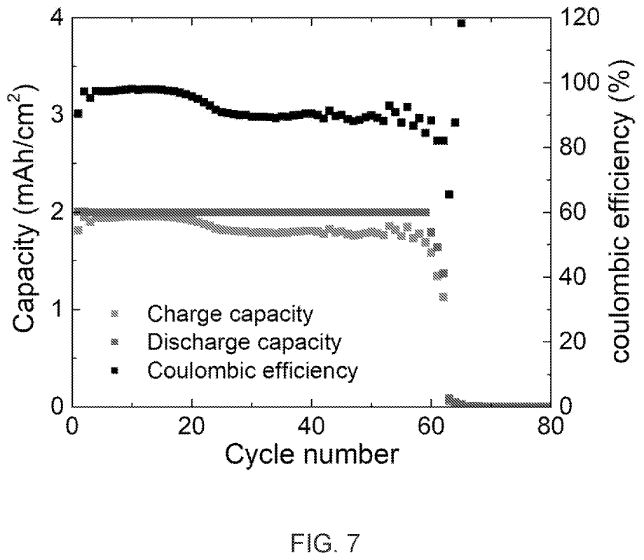

A test half cell with a 30 μm thick Al foil working electrode and a Li counter electrode was subjected to galvanostatic cycling. The electrolyte placed between the Al and Li electrodes was 1 M LiPF₆ in a 50:50 mixture (by volume) of ethylene carbonate (EC) and diethyl carbonate (DEC) with 10% fluoroethylene carbonate. The cells were cycled using a current density of 0.2 mA/cm² for the first two cycles and then 1 mA/cm² for subsequent cycles. A plot of the galvanostatic cycling data is shown in FIG. 7.

### Example 5—Al—Sn Alloy Half Cell

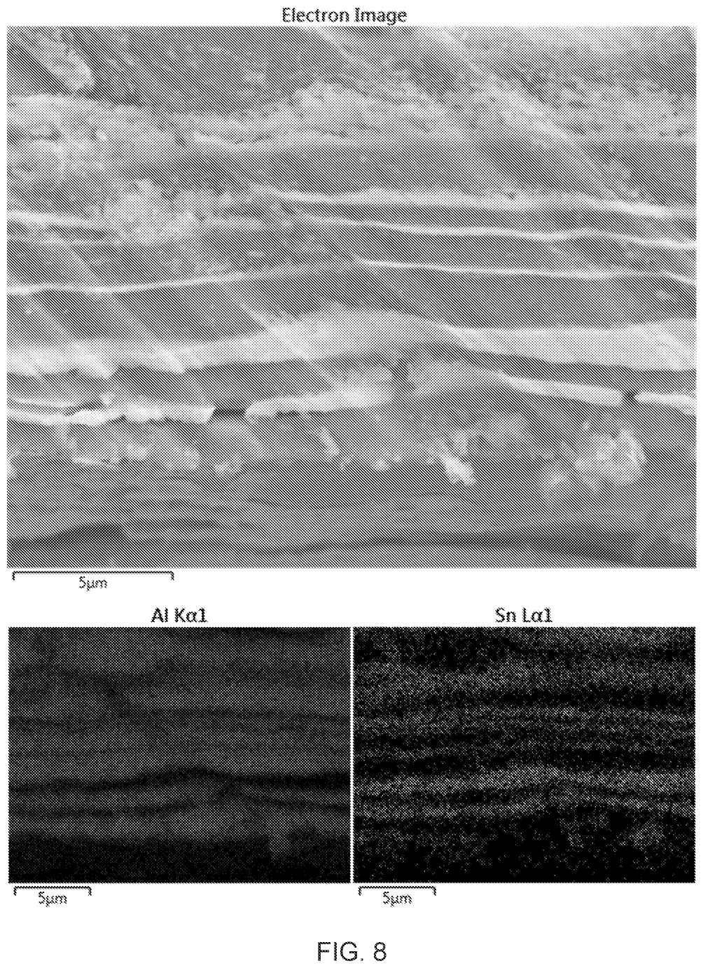

A composite of 65% Al and 35% Sn was created as a foil. An electron micrograph image of the foil is shown in FIG. 8, as well as x-ray microanalysis showing distribution of Al and Sn in the composite.

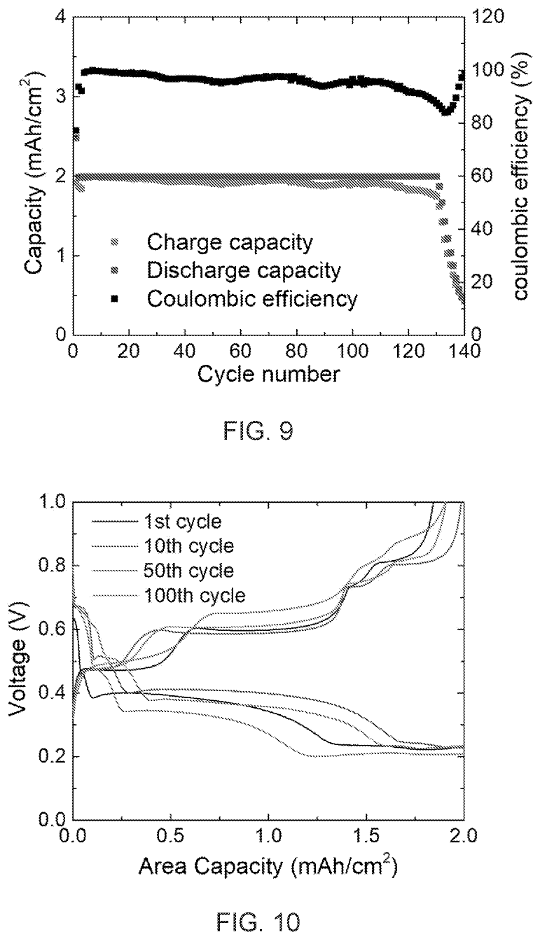

The composite foil (30 μm thick) was used as a working electrode in a test half cell with a Li counter electrode. The half cell was subjected to galvanostatic cycling. The electrolyte placed between the working and Li electrodes was 1 M LiPF₆ in a 50:50 mixture (by volume) of ethylene carbonate (EC) and diethyl carbonate (DEC) with 10% fluoroethylene carbonate. The cells were cycled using a current density of 0.2 mA/cm² for the first two cycles and then 1 mA/cm² for subsequent cycles. A plot of the galvanostatic cycling data is shown in FIG. 9. FIG. 10 shows a plot of several charge and discharge curves for the example half cell.

### Example 6—Al—Zn Alloy Half Cell

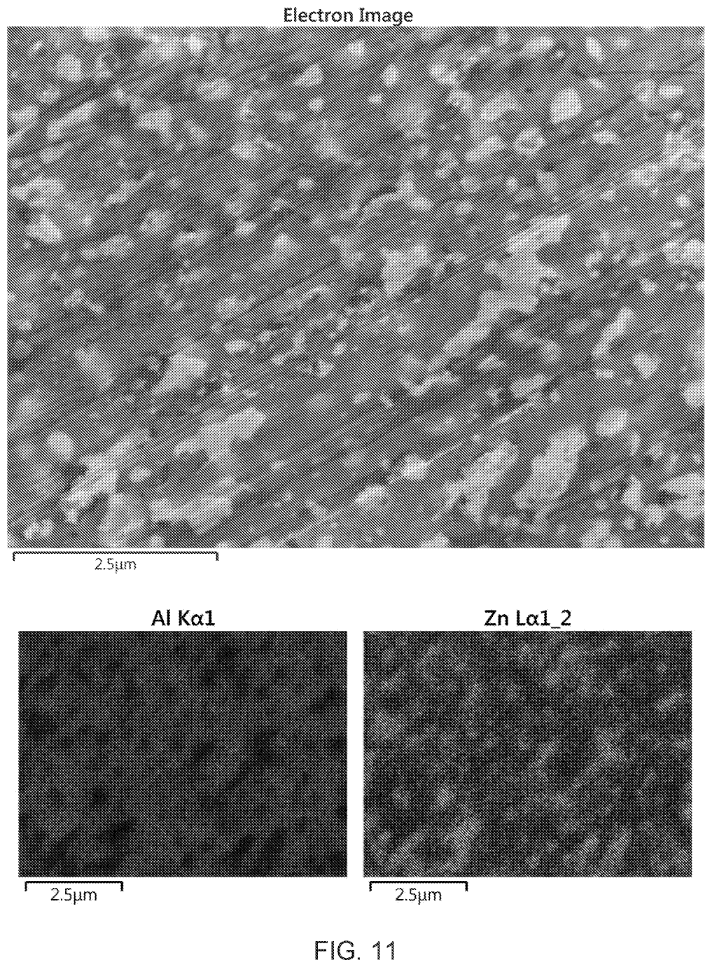

A composite of 51% Al and 49% Zn was created as a foil. An electron micrograph image of the foil is shown in FIG. 11, as well as x-ray microanalysis showing distribution of Al and Zn in the composite.

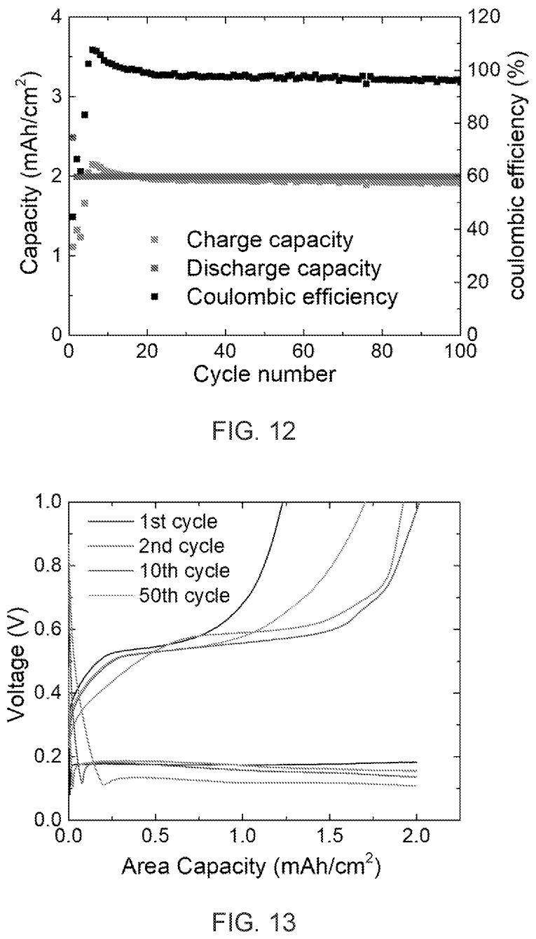

The composite foil (30 μm thick) was used as a working electrode in a test half cell with a Li counter electrode. The half cell was subjected to galvanostatic cycling. The electrolyte placed between the working and Li electrodes was 1 M LiPF₆ in a 50:50 mixture (by volume) of ethylene carbonate (EC) and diethyl carbonate (DEC) with 10% fluoroethylene carbonate. The cells were cycled using a current density of 0.2 mA/cm² for the first two cycles and then 1 mA/cm² for subsequent cycles. A plot of the galvanostatic cycling data is shown in FIG. 12. FIG. 13 shows a plot of several charge and discharge curves for the example half cell.

### Example 7—Al—Si Alloy Half Cell

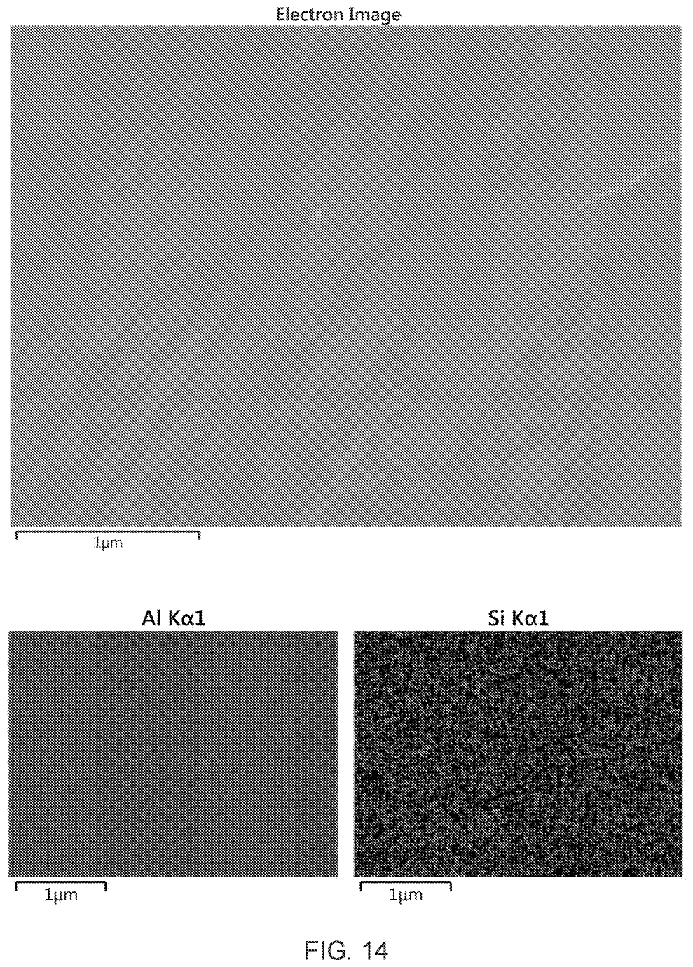

A composite of 99% Al and 1% Si was created as a foil. An electron micrograph image of the foil is shown in FIG. 14, as well as x-ray microanalysis showing distribution of Al and Si in the composite.

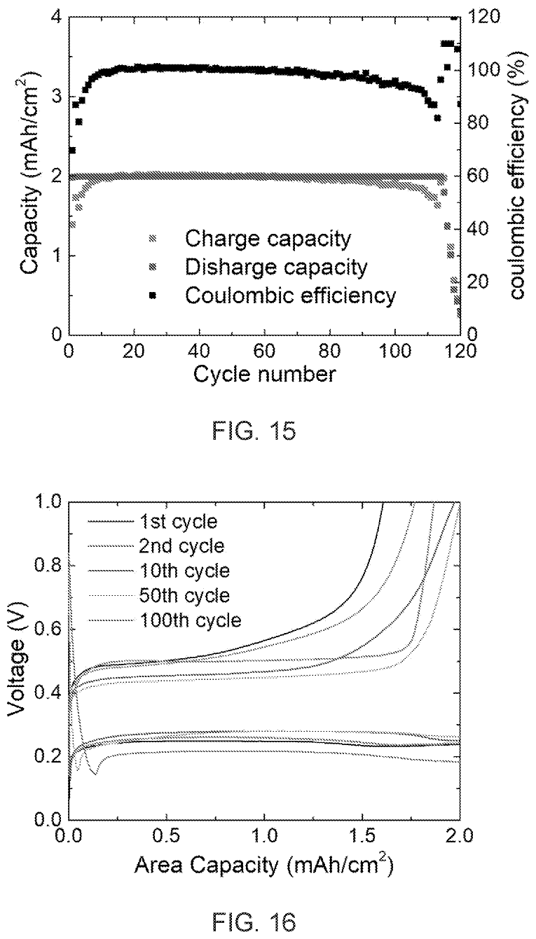

The composite foil (30 μm thick) was used as a working electrode in a test half cell with a Li counter electrode. The half cell was subjected to galvanostatic cycling. The electrolyte placed between the working and Li electrodes was 1 M LiPF₆ in a 50:50 mixture (by volume) of ethylene carbonate (EC) and diethyl carbonate (DEC) with 10% fluoroethylene carbonate. The cells were cycled using a current density of 0.2 mA/cm² for the first two cycles and then 1 mA/cm² for subsequent cycles. A plot of the galvanostatic cycling data is shown in FIG. 15. FIG. 16 shows a plot of several charge and discharge curves for the example half cell.

### Illustrative Aspects

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a composite comprising at least one layer, the at least one layer comprising: a first plurality of particles selected from at least one of Al particles and Al alloy particles; and a second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fe₃O₄, FeS, CuO, or combinations thereof.

Aspect 2 is the composite of any previous or subsequent aspect, wherein the composite allows transmission of lithium atoms or lithium ions to the Al particles.

Aspect 3 is the composite of any previous or subsequent aspect, wherein the lithium atoms or lithium ions are at least one of absorbed, stored, or released by the composite.

Aspect 4 is the composite of any previous or subsequent aspect, comprising 1 to 99 wt. % Al metal or alloy based upon the total weight of the composite.

Aspect 5 is the composite of any previous or subsequent aspect, comprising from 40 to 70 wt. % Al metal or alloy.

Aspect 6 is the composite of any previous or subsequent aspect, wherein the first plurality of particles has an average particle size from 10 nm to 100 μm and the second plurality of particles has an average particle size from 10 nm to 100 μm.

Aspect 7 is the composite of any previous or subsequent aspect, wherein the first plurality of particles and second plurality of particles each have a purity of 90 wt. % or more.

Aspect 8 is the composite of any previous or subsequent aspect, wherein the second plurality of particles are metal particles.

Aspect 9 is the composite of any previous or subsequent aspect, wherein the second plurality of particles are non-metal particles.

Aspect 10 is the composite of any previous or subsequent aspect, wherein the composite collects lithium at a potential of from 0 V to 5 V vs. Li/Li+.

Aspect 11 is the composite of any previous or subsequent aspect, characterized as having a specific capacity of from 450 mAh/g to 1000 mAh/g for at least 14 cycles (120 hours).

Aspect 12 is the composite of any previous or subsequent aspect, characterized as having a lithiation percentage of from 50% to 100% and a specific capacity of from 450 mAh/g to 1000 mAh/g for at least 14 cycles (120 hours).

Aspect 13 is the composite of any previous or subsequent aspect, having an oxygen content of 50 atomic % or less.

Aspect 14 is the composite of any previous or subsequent aspect, wherein the composite forms a substrate having a thickness of from 10 nm to 150 μm.

Aspect 15 is the composite of any previous or subsequent aspect, wherein the first plurality of particles selected from at least one of Al particles and Al alloy particles is in the form of a powder.

Aspect 16 is the composite of any previous or subsequent aspect, wherein the second plurality of particles selected from at least one of metal particles and non-metal particles is in the form of a powder.

Aspect 17 is the composite of any previous or subsequent aspect, wherein the Al metal or alloy comprises an Al alloy sheet or an Al alloy foil having a thickness of from 10 nm to 100 μm.

Aspect 18 is the composite of any previous or subsequent aspect, wherein the second plurality of particles comprises a metal or metal alloy sheet or a metal or metal alloy foil having a thickness of from 10 nm to 100 μm.

Aspect 19 is the composite of any previous or subsequent aspect, comprising or corresponding to an electronic substrate, a current collector, a capacitor, a supercapacitor, a current collector for an electrochemical cell, a current collector for a lithium-ion electrochemical cell, or combinations thereof.

Aspect 20 is the composite of any previous or subsequent aspect, comprising or exhibiting a micro-porous or nano-porous structure.

Aspect 21 is the composite of any previous or subsequent aspect, comprising or corresponding to an active anode for a lithium-ion electrochemical cell.

Aspect 22 is a device comprising: a first electrochemical cell electrode comprising a composite having at least one layer, wherein the composite is one or both of a current collector and an electrode active material, wherein the at least one layer includes: a first plurality of particles selected from at least one of Al particles and Al alloy particles; and a second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fe₃O₄, FeS, CuO, or combinations thereof; a second electrochemical cell electrode; and an electrolyte positioned between the first electrochemical cell electrode and the second electrochemical cell electrode.

Aspect 23 is the device of any previous or subsequent aspect, wherein the electrode active material comprises a lithium-ion cathode active material or a lithium-ion anode active material.

Aspect 24 is the device of any previous or subsequent aspect, comprising or corresponding to an electrochemical cell, a battery, a portable electronic device, or combinations thereof.

Aspect 25 is the device of any previous or subsequent aspect, further comprising: electronic device circuitry in direct or indirect electrical communication with and drawing or receiving current from the first electrochemical cell electrode or the second electrochemical cell electrode.

Aspect 26 is the device of any previous or subsequent aspect, the composite comprising or corresponding to the composite of any previous or subsequent aspect.

Aspect 27 is a method of making a composite having at least one layer, the method comprising: mixing a first plurality of particles and a second plurality of particles to form a homogeneous mixture, the first plurality of particles selected from at least one of Al particles and Al alloy particles, and the second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fe₃O₄, FeS, CuO, or combinations thereof; mechanically, thermally, or thermomechanically processing the mixture to form at least one layer of a composite.

Aspect 28 is the method of any previous or subsequent aspect, wherein the mechanically, thermally, or thermomechanically processing the mixture includes rolling, power processing, and/or chemical vapor deposition.

Aspect 29 is the method of any previous or subsequent aspect, the composite comprising or corresponding to the composite of any previous or subsequent aspect.

Aspect 30 is a composite comprising at least one layer, the at least one layer comprising: an alloy comprising Al and at least one additional component, the at least one additional component comprising at least one of zinc, silicon, bismuth, copper, germanium, indium, antimony, tin, magnesium, or combinations thereof.

Aspect 31 is the composite of any previous or subsequent aspect, wherein the composite allows transmission of lithium atoms or lithium ions to the Al.

Aspect 32 is the composite of any previous or subsequent aspect, wherein lithium atoms or lithium ions are at least one of absorbed, stored, or released by the composite.

Aspect 33 is the composite of any previous or subsequent aspect, comprising 1 to 99 wt. % of the alloy, based upon the total weight of the composite.

Aspect 34 is the composite of any previous or subsequent aspect, comprising from 40 to 70 wt. % of the alloy.

Aspect 35 is the composite of any previous or subsequent aspect, wherein the composite collects lithium at a potential of from 0 V to 5 V vs. Li/Li+.

Aspect 36 is the composite of any previous or subsequent aspect, characterized as having a specific capacity of from 450 mAh/g to 1000 mAh/g for at least 14 cycles (120 hours).

Aspect 37 is the composite of any previous or subsequent aspect, characterized as having a lithiation percentage of from 50% to 100% and a specific capacity of from 450 mAh/g to 1000 mAh/g for at least 14 cycles (120 hours).

Aspect 38 is the composite of any previous or subsequent aspect, having an oxygen content of 50 atomic % or less.

Aspect 39 is the composite of any previous or subsequent aspect, wherein the composite forms a substrate having a thickness of from 10 nm to 150 μm.

Aspect 40 is the composite of any previous or subsequent aspect, wherein the alloy comprises an Al alloy sheet or an Al alloy foil having a thickness of from 10 nm to 100 μm.

Aspect 41 is the composite of any previous or subsequent aspect, comprising or corresponding to an electronic substrate, a current collector, a capacitor, a supercapacitor, a current collector for an electrochemical cell, a current collector for a lithium-ion electrochemical cell, or combinations thereof.

Aspect 42 is the composite of any previous or subsequent aspect, comprising or exhibiting a micro-porous or nano-porous structure.

Aspect 43 is the composite of any previous or subsequent aspect, comprising or corresponding to an active anode for a lithium-ion electrochemical cell.

Aspect 44 is a device comprising: a first electrochemical cell electrode comprising a composite having at least one layer, wherein the composite is one or both of a current collector and an electrode active material, wherein the at least one layer includes: an alloy comprising Al and at least one additional component, the at least one additional component comprising at least one of zinc, silicon, bismuth, copper, germanium, indium, antimony, tin, magnesium, or combinations thereof; a second electrochemical cell electrode; and an electrolyte positioned between the first electrochemical cell electrode and the second electrochemical cell electrode.

Aspect 45 is the device of any previous or subsequent aspect, wherein the electrode active material comprises a lithium-ion cathode active material or a lithium-ion anode active material.

Aspect 46 is the device of any previous or subsequent aspect, comprising or corresponding to an electrochemical cell, a battery, a portable electronic device, or combinations thereof.

Aspect 47 is the device of any previous or subsequent aspect, further comprising: electronic device circuitry in direct or indirect electrical communication with and drawing or receiving current from the first electrochemical cell electrode or the second electrochemical cell electrode.

Aspect 48 is the device of any previous or subsequent aspect, wherein the composite comprises a micro-porous or nano-porous structure.

Aspect 49 is the device of any previous or subsequent aspect, the composite comprising or corresponding to the composite of any previous or subsequent aspect.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1. A composite comprising at least one layer, the at least one layer comprising:
a first plurality of particles selected from at least one of Al particles and Al alloy particles; and
a second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, CO₂O₄, MnO₂, Fe₂O₃, Fe₃O₄, FeS, CuO, or combinations thereof.

2. The composite of claim 1, wherein the composite allows transmission of lithium atoms or lithium ions to the Al particles.

3. (canceled)

4. The composite of claim 1, comprising 1 to 99 wt. % Al metal or alloy based upon a total weight of the composite.

5. The composite of claim 4, comprising from 40 to 70 wt. % Al metal or alloy.

6. The composite of claim 1, wherein the first plurality of particles has an average particle size from 10 nm to 100 μm and the second plurality of particles has an average particle size from 10 nm to 100 μm.

7. The composite of claim 1, wherein the first plurality of particles and second plurality of particles each have a purity of 90 wt. % or more.

8. (canceled)

9. (canceled)

10. The composite of claim 1, wherein the composite collects lithium at a potential of from 0 V to 5 V vs. Li/Li⁺.

11. The composite of claim 1, characterized as having a specific capacity of from 450 mAh/g to 1000 mAh/g for at least 14 cycles (120 hours).

12. The composite of claim 1, characterized as having a lithiation percentage of from 50% to 100% and a specific capacity of from 450 mAh/g to 1000 mAh/g for at least 14 cycles (120 hours).

13. The composite of claim 1, having an oxygen content of 50 atomic % or less.

14. (canceled)

15. The composite of claim 1, wherein the first plurality of particles selected from at least one of Al particles and Al alloy particles is in a powder form or wherein the second plurality of particles selected from at least one of metal particles and non-metal particles is in a powder form.

16. (canceled)

17. The composite of claim 4, wherein the Al metal or alloy comprises an Al alloy sheet or an Al alloy foil having a thickness of from 10 nm to 100 μm or wherein the second plurality of particles comprises a metal or metal alloy sheet or a metal or metal alloy foil having a thickness of from 10 nm to 100 μm.

18. (canceled)

19. The composite of claim 1, comprising or corresponding to an electronic substrate, a current collector, a capacitor, a supercapacitor, a current collector for an electrochemical cell, a current collector for a lithium-ion electrochemical cell, or combinations thereof.

20. The composite of claim 1, comprising or exhibiting a micro-porous or nano-porous structure.

21. The composite of claim 1, comprising or corresponding to an active anode for a lithium-ion electrochemical cell.

22. A device comprising:
a first electrochemical cell electrode comprising a composite having at least one layer, wherein the composite is one or both of a current collector and an electrode active material, wherein the at least one layer includes:
a first plurality of particles selected from at least one of Al particles and Al alloy particles; and
a second plurality of particles selected from at least one of metal particles and non-metal particles, wherein the metal particles are selected from at least one of zinc, silicon, bismuth, copper, germanium, indium, antimony, tin, magnesium, or combinations thereof, and the non-metal particles are selected from at least one of carbon, lithium titanium oxide, titania, MoO, MoS₂, Co₂O₄, MnO₂, Fe₂O₃, Fe₃O₄, FeS, CuO, or combinations thereof;
a second electrochemical cell electrode; and
an electrolyte positioned between the first electrochemical cell electrode and the second electrochemical cell electrode.

23. (canceled)

24. (canceled)

25. (canceled)

26. (canceled)

27. (canceled)

28. (canceled)

29. (canceled)

30. A composite comprising at least one layer, the at least one layer comprising: an alloy comprising Al and at least one additional component, the at least one additional component comprising at least one of zinc, silicon, bismuth, copper, germanium, indium, antimony, tin, magnesium, or combinations thereof.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. The composite of claim 30, comprising or exhibiting a micro-porous or nano-porous structure.

43. (canceled)

44. (canceled)

45. (canceled)

46. (canceled)

47. (canceled)

48. (canceled)

49. (canceled)
